(19) United States
(12) Patent Application Publication
(10) Pub. No.: US 2010/0306075 A1
(43) Pub. Date: Dec. 2, 2010

(54) SYSTEMS AND METHODS FOR ACCESSING CRUISE SERVICES USING A PORTABLE ELECTRONIC DEVICE

(75) Inventors: Kaiann Drance, San Jose, CA (US); Stanley Carl Ng, Los Altos, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/564,512

(22) Filed: Sep. 22, 2009

Related U.S. Application Data
(60) Provisional application No. 61/183,158, filed on Jun. 2, 2009.

(51) Int. Cl. G06Q 30/00

(52) U.S. Cl. 705/26; 705/14.66; 705/1.1

(57) ABSTRACT

This is directed to systems and methods for accessing cruise services using a single, integrated application available to a portable electronic device. Through the integrated application, a user can access and control cruise services throughout all aspects of the cruise experience, including before booking a cruise, before boarding a cruise, while on the cruise ship, when a cruise ship is docked at a port, and after the cruise has finished. In some embodiments, the integrated application can provide the user with notifications of available cruise activities. For example, unsold cruise activities for cruise activities that can be purchased can be identified. The user can then be provided with a notification of the unsold cruise activity, provided with an option to purchase the unsold cruise activity, or both.

### CROSS-REFERENCE TO RELATED APPLICATIONS

This application claims the benefit of U.S. Provisional Patent Application No. 61/183,158, filed on Jun. 2, 2009, which is hereby incorporated by reference herein in its entirety.

### FIELD OF THE DISCLOSURE

This relates to systems and methods for accessing cruise services using a portable electronic device. In particular, this relates to systems and methods for providing notifications of unsold cruise activities via a portable electronic device to customers on a cruise.

### BACKGROUND OF THE DISCLOSURE

Going on a cruise is an pastime enjoyed by many people. Cruises can allow one to go on a vacation that not only provides for the basic needs of its patrons (e.g., food, drinks, and housing), but also allows one to travel, explore new cities, take part in guided tours or “excursions” into these new cities, and treat oneself to onboard activities such as, for example, shows, casinos, spa appointments, and health club classes. In this way, going on a cruise is a unique experience that is different from, for example, other vacations or trips because it allows customers to take part in a wide variety of activities through one service provider.

When a customer goes on a cruise, many interactions between the customer and the cruise service providers can take place. For example, a customer can interact with a cruise service provider to research the cruise line, to make a reservation, to obtain information related to onboard activities, excursions, or both, and to obtain post-cruise amenities. All of these interactions can require distinct actions from the user from different devices or elements. For example, a user can browse an on-line website to research a company, a user can call to make a reservation, a user may receive pamphlets listing onboard activities, excursions, or both under their door every morning of the cruise, and a user may sign up to receive follow-up promotions and coupons by e-mail after the cruise has ended.

Although this combination of approaches for interacting with a cruise service provider can be serviceable, it remains cumbersome and requires the cruise service provider to accommodate all of the possible forms of interaction. From a user's perspective, the lack of centralization of interactions with the cruise service provider and with the available cruise services can require more effort from the user than desired, and perhaps even dissuade the user from going on a cruise or using available cruise services (thus at a cost to the cruise service provider).

### SUMMARY OF THE DISCLOSURE

Systems and methods for providing an integrated interface for accessing cruise services using a portable electronic device are provided. The cruise services can include, for example, promotions and coupons associated with the cruise service provider, a listing of available cruise activities, maps of the cruise ship, a user interface for controlling entertainment systems and temperature within a user's cabin, a listing of safety and emergency information, providing notifications of and opportunities to purchase unsold cruise activities, and any other suitable cruise services.

To access the cruise services, the electronic device can interface with the cruise system using any suitable approach. In some embodiments, the electronic device can securely connect to one or more servers associated with the cruise service provider. For example, the electronic device can connect with distinct servers associated with ordering services or goods from the cruise (e.g., room service). As another example, the electronic device can connect with distinct servers associated with attractions, shops, or stores for which the user can make reservations, purchases, or access information (e.g., for shops and attractions within the cruise ship or within a city at which the cruise ship docks).

In some embodiments, a user can be provided with notifications of available cruise activities. In particular, in some embodiments a user can be provided with notifications of unsold cruise activities. For example, oftentimes a cruise may offer cruise activities that can be purchased, such as onshore excursions, tickets to shows, spa appointments, spots in fitness classes such as yoga classes, or any other purchasable cruise activity. When spots in such a cruise activity are unsold, notifications of the unsold activity can be provided to a user. The notification may include, for example, information related to the unsold cruise activity, an option to purchase the unsold cruise activity, or both. In some embodiments, targeted notifications can be provided by comparing attributes of an unsold cruise activity to a user profile of the user. In response the attributes of the unsold cruise activity matching the user profile, the user can be provided with a notification of the unsold cruise activity.

### BRIEF DESCRIPTION OF THE DRAWINGS

The above and other features of the invention, its nature and various advantages will be more apparent upon consideration of the following detailed description, taken in conjunction with the accompanying drawings in which:

FIG. 1 is a schematic view of an illustrative electronic device for providing an application operative to interface with a cruise system in accordance with some embodiments of the invention;

FIG. 2 is a schematic diagram of several situations during which a user can make use of a single, integrated application to interface with a cruise system in accordance with some embodiments of the invention;

FIG. 3 is a schematic diagram of advantages of an integrated application for enhancing a user's cruise experience in accordance with some embodiments of the invention;

FIG. 4 is a schematic diagram of functions related to planning a cruise that are available to a user in accordance with some embodiments of the invention;

FIG. 5 is an illustrative notification provided by a cruise service provider via an integrated cruise application in accordance with some embodiments of the invention;

FIG. 6 is a schematic diagram of functions related to initially boarding a cruise that are available to a user in accordance with some embodiments of the invention;

FIG. 7 is a schematic diagram of functions related to onboard proceedings that are available to a user in accordance with some embodiments of the invention;

FIG. 8 is an illustrative notification provided by a cruise service provider via an integrated cruise application in accordance with some embodiments of the invention;

FIG. 9 is a schematic diagram of functions related to onshore proceedings that are available to a user in accordance with some embodiments of the invention;

FIG. 10 is an illustrative user interface for providing notifications of unsold cruise activities in accordance with some embodiments of the invention;

FIG. 11 is an illustrative process for providing notifications of cruise activities in accordance with some embodiments of the invention; and

FIG. 12 is a schematic diagram of functions available to a user following a cruise in accordance with some embodiments of the invention.

### DETAILED DESCRIPTION

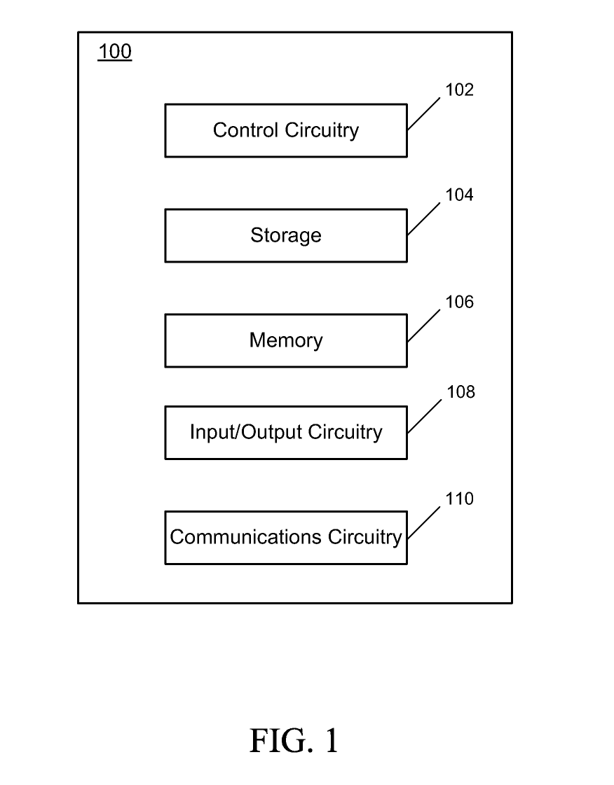

FIG. 1 is a schematic view of an illustrative electronic device for providing an application operative to interface with a cruise system in accordance with some embodiments. Electronic device 100 can include control circuitry 102, storage 104, memory 106, Input/Output (“I/O”) circuitry 108, and communications circuitry 110. In some embodiments, one or more of the components of electronic device 100 can be combined or omitted (e.g., storage 104 and memory 106 may be combined). In some embodiments, electronic device 100 can include other components not combined or included in those shown in FIG. 1 (e.g., motion detection components, a power supply such as a battery or kinetics, a display, bus, or input mechanism, etc.), or several instances of the components shown in FIG. 1. For the sake of simplicity, only one of each of the components is shown in FIG. 1.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface of device 100.

Storage 104 can include, for example, one or more storage mediums including a hard-drive, solid state drive, flash memory, permanent memory such as read-only memory (“ROM”), any other suitable type of storage component, or any combination thereof. Storage 104 can store, for example, media data (e.g., music and video files), application data (e.g., for implementing functions on electronic device 100), firmware, authentication information (e.g., libraries of data associated with authorized users), user profile and lifestyle data (e.g., food preferences, activity preferences, age, gender, or any other suitable user profile data), transaction information data (e.g., information such as credit card information), wireless connection information data, contact information data (e.g., telephone numbers and email addresses), calendar information data, and any other suitable data or any combination thereof.

Memory 106 can include cache memory, semi-permanent memory such as random-access memory (“RAM”), or any other suitable type of memory used for temporarily storing data. In some embodiments, memory 106 can also be used for storing data used to operate electronic device applications, or any other type of data that can be stored in storage 104. In some embodiments, memory 106 and storage 104 can be combined as a single storage medium.

Input/output (“I/O”) circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen or button), physical movements (e.g., from a mouse or sensor), analog audio signals (e.g., from a microphone), or any other input. The digital data can be provided to and received from control circuitry 102, storage 104, memory 106, or any other component of electronic device 100.

Electronic device 100 can include any suitable interface or component for allowing a user to provide inputs to I/O circuitry 108. For example, electronic device 100 can include any suitable input mechanism, such as for example, a button, keypad, dial, click wheel, switch, touch screen, or any combination of the above. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to device 100 with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronic device 100. As another example, the display circuitry can include a movable display or a projecting system for providing a display of content on a surface remote from electronic device 100 (e.g., a video projector). In some embodiments, the display circuitry can include a coder/decoder (“CODEC”) to convert digital media data into analog signals. For example, the display circuitry (or other appropriate circuitry within electronic device 100) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and transmit or receive communications (e.g., voice, data, or both) to and/or from electronic device 100. For example, in some embodiments, communications circuitry 110 can be utilized to couple electronic device 100 to an external database of information, to a server, to another electronic device, or any combination of the above. As another example, communications circuitry 110 can be operative to interface with a communications network using any suitable communications protocol such as, for example, Wi-Fi (e.g., a 802.11 protocol), Bluetooth®, near field communications (“NFC”), radio frequency systems (e.g., 900 MHz, 2.4 GHz, and 5.6 GHz communication systems), infrared, GSM, GSM plus EDGE, CDMA, quadband, other cellular protocols, VOIP, or any other suitable protocol.

In some embodiments, electronic device 100 can be coupled to a host device. For example, electronic device 100 may be coupled to a host device for transferring data, synching the electronic devices, updating software or firmware, providing performance information to a remote source, or performing any other suitable operation that can require electronic device 100 to be coupled to a host device.

Electronic device 100 can include any suitable type of electronic device. For example, electronic device 100 can include a portable electronic device that the user may hold in his or her hand, such as a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer.

Electronic device 100 may include an application operative to interface with a cruise system in any suitable manner. As one illustration, the application may provide access to different services provided by the cruise service provider. For example, the application can connect to a cruise service provider's website or server to download information, promotions, or both to aid a user in researching a cruise to potentially purchase. As another example, the application can connect to a database of cruise activities to provide a user currently on a cruise with a listing of available cruise activities. A particular listing of cruise activities may be presented to the user based on, for example, cruise activities available that same day, cruise activities that are undergoing special promotions, or cruise activities that match a user profile of the user. More examples of ways in which an application of an electronic device can interface with a cruise system will be described in more detail below.

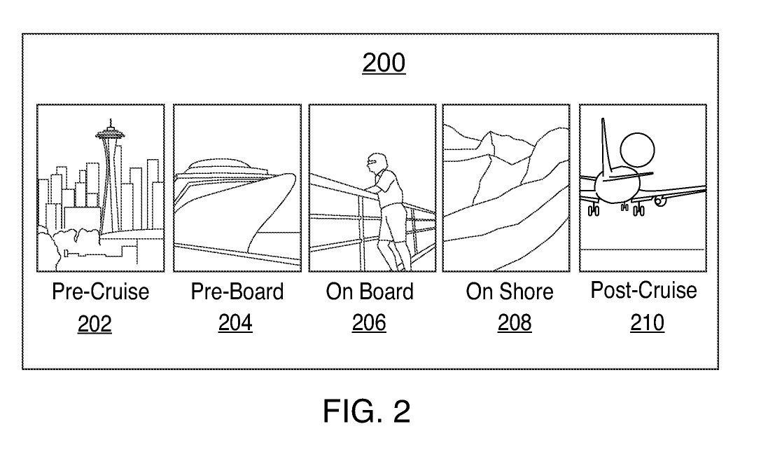

In this manner, electronic device 100 can allow a user to perform a variety of different functions, thus enhancing the user's cruise experience. In some embodiments, these different functions can be provided in a signal, integrated application of the electronic device. For example, FIG. 2 shows diagram 200 of several illustrative situations during which a user can make use of a single, integrated application to interface with a cruise system. These situations may include, for example, pre-cruise scenario 202 while the user is planning a cruise itinerary (e.g., while booking a cruise or researching a cruise line), pre-board scenario 204 before the user's initial arrival to the cruise ship, onboard scenario 206 while the user is on the cruise ship, onshore scenario 208 when the cruise ship docks at a port, and post-cruise scenario 210 after the cruise has ended. Furthermore, although FIG. 2 shows specific illustrations (e.g., scenarios 202, 204, 206, 208, and 210), one skilled in the art could appreciate that a single, integrated application to interface with a cruise system could alternatively or additionally be used in any suitable situation.

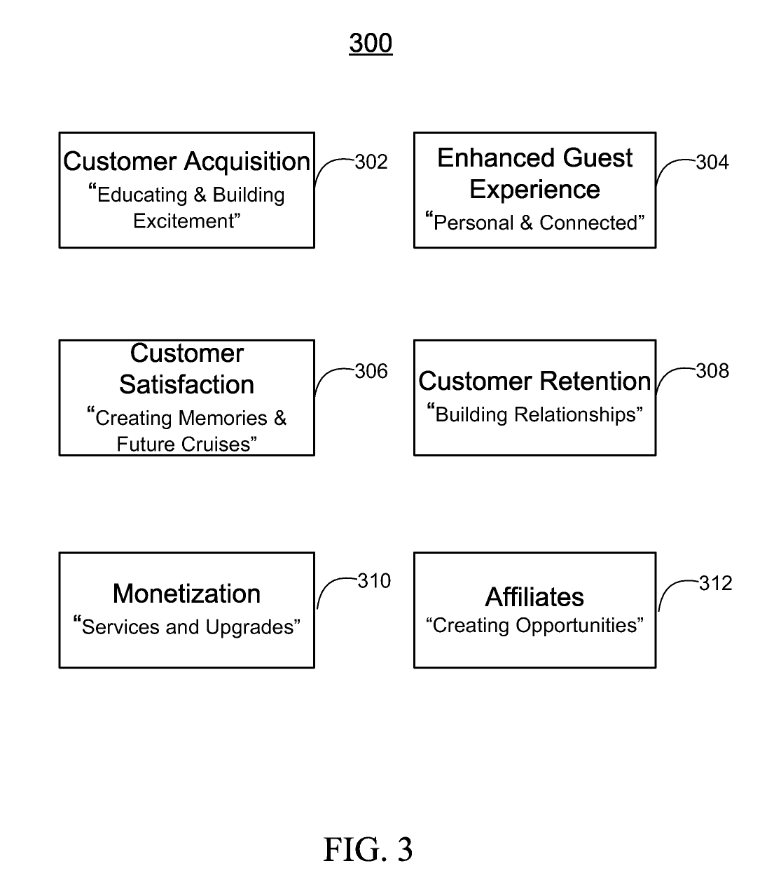

Advantages of such a single integrated application can include, as indicated by diagram 300 of FIG. 3, customer acquisition 302. For example, through the integrated application, a potential cruise customer can research various cruise lines and destinations, receive information regarding available cruises, and otherwise be educated about and build excitement for a potential cruise trip. Advantages can also include controlling and creating an enhanced guest experience 304. For example, the integrated application can create customer continuity with a particular cruise service provider, and may provide the user with an on-going experience that is personalized for their needs and preferences. Moreover, an enhanced guest experience and the other conveniences offered by the integrated application can promote customer satisfaction 306. In this manner, the application can play an integral part in creating memories for a cruise customer and promoting the customer to embark on future cruise trips.

As another illustration, the advantages of a single integrated application may also include customer retention 308, for example, by allowing an efficient way to build customer relations and retain current customers. For example, through the integrated application, a cruise service may be able to address a customer's needs 24 hours a day and 7 days a week, thus providing the utmost satisfaction for the customer. Advantages can also include monetization 310, for example by providing a user with convenient access to services and upgrades. In this manner, not only may the cruise ship provider have the opportunity to present more upgrades and services to a user (and generate more income), but the user can be provided with a wide arrangement of available products at their fingertips. In some embodiments, the upgrades and services that are presented to the user may be personalized to match the user's preferences. Furthermore, the advantages may include creating affiliate opportunities 312. For example, the cruise service can provide a user with opportunities or services made available by affiliate companies through the integrated application.

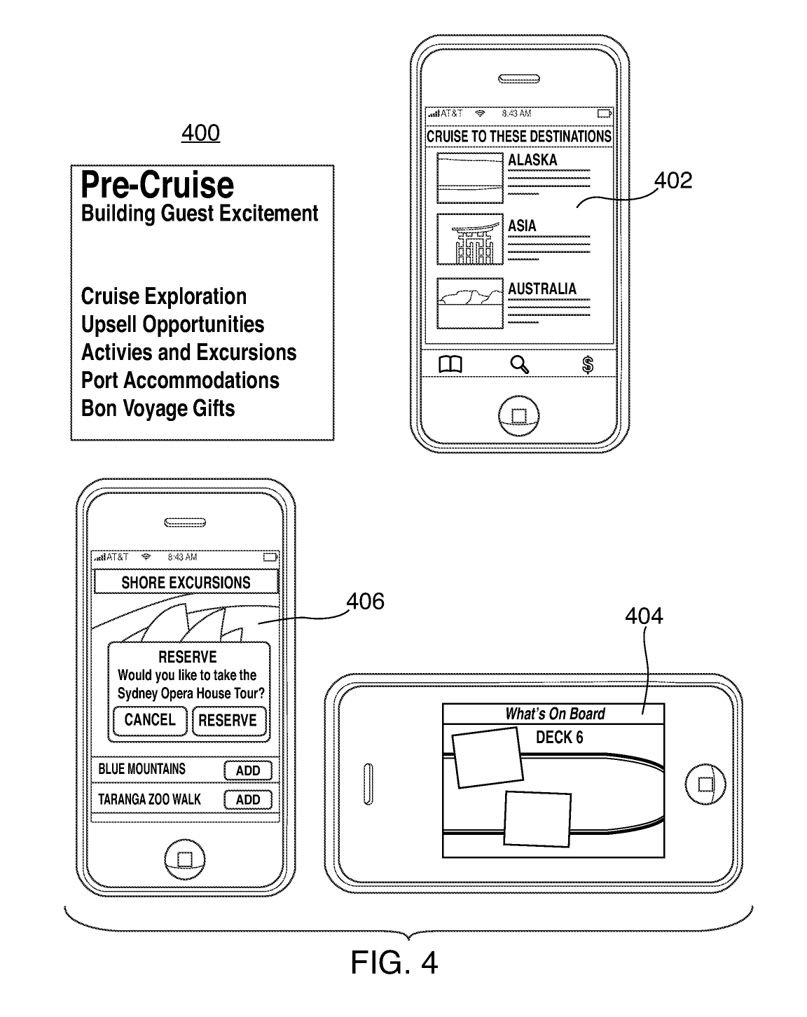

FIG. 4 shows diagram 400 of illustrative functions related to planning a cruise that may be available to a user through a single, integrated application. For example, the functions of FIG. 4 may be available to a user during pre-cruise scenario 202 of FIG. 2. However, one skilled in the art could appreciate that the functions of FIG. 4 are not limited to a pre-cruise scenario or to the particular functions listed in FIG. 4, and rather may include any suitable functions or be used in any suitable scenario.

As generally indicated in diagram 400, an integrated application for accessing cruise services can help build excitement in a potential cruise customer about going on a cruise. For example, through the integrated application, a user can research a cruise service provider, view upsell opportunities, view activities and excursions available on a cruise, view port accommodations, create cruise reservations, access cruise reservations, modify cruise reservations, receive “bon voyage gifts,” perform any other suitable function related to planning a cruise, or any combination of the above. As one illustration, user interface 402 shows an exemplary interface in which a user can research cruise services by viewing potential cruise destinations. As another illustration, user interface 404 shows an exemplary interface in which a user can research a cruise line by viewing maps of a cruise ship.

In some embodiments, an integrated application for accessing cruise services can provide a user with upsell opportunities. For example, user interface 406 shows an exemplary upsell opportunity that can be presented to a user in a scenario such as pre-cruise scenario 202 of FIG. 2. In this illustration, a user is offered the opportunity to add a “Sydney Opera House Tour” to their cruise reservation. Alternatively, any other suitable activity, excursion, or upsell opportunity can be offered to a user. In some embodiments, the integrated application can allow a user to perform secure transactions (e.g., using a credit card). For example, the user can perform a secure transaction to purchase a cruise, purchase a cruise activity, place a deposit to reserve an upsell opportunity, or perform any other suitable function.

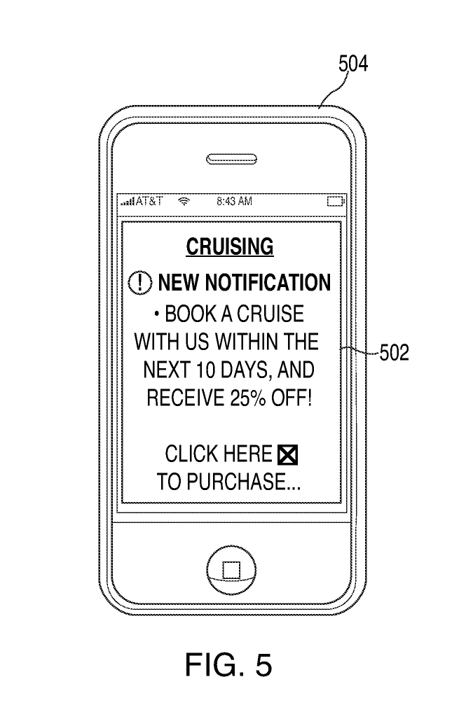

In some embodiments, a cruise service provider can transmit offers and promotions to a customer through the integrated application. For example, as illustrated in FIG. 5, a potential customer can receive notification 502 via electronic device 504 that a cruise service is currently offering discounted prices. Notification 502 may include, for example, a push notification that utilizes an internet protocol (“IP”) connection to forward notifications from the servers of third party applications to electronic device 504. In this manner, functions such as those illustrated in FIG. 4 and FIG. 5 can initiate a relationship with a potential customer, and furthermore can provide information and services that may build excitement in the customer about the idea of going on a cruise with a cruise service provider.

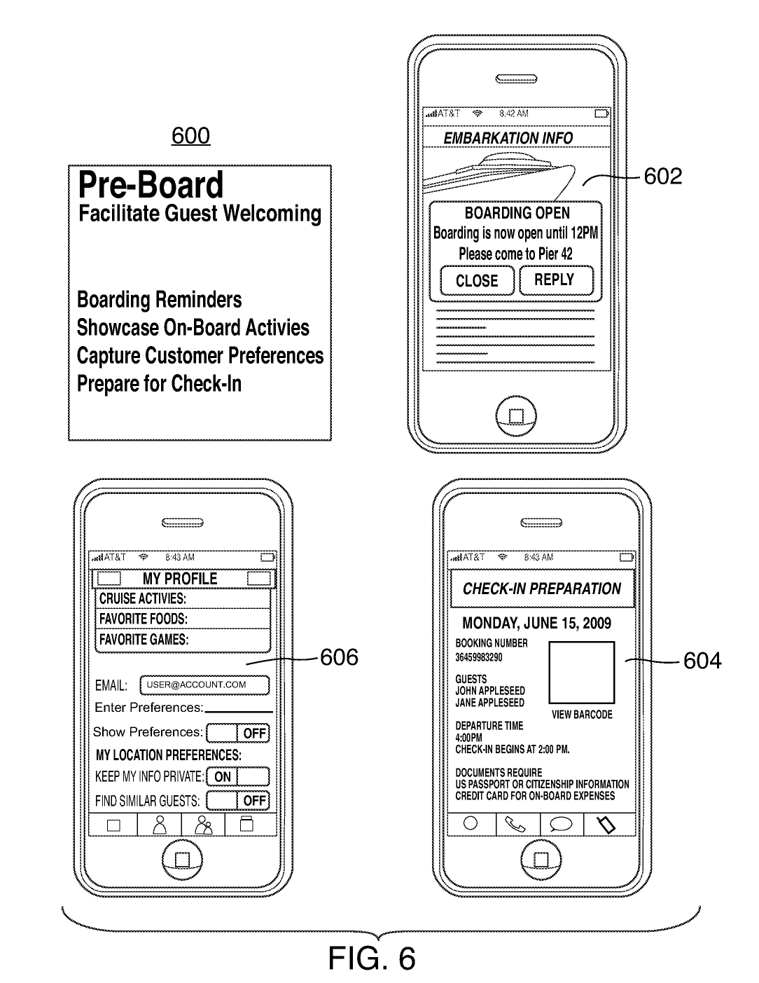

FIG. 6 shows diagram 600 of various functions related to initially boarding a cruise that may be available to a user through a single, integrated application. For example, the functions of FIG. 6 may be available to a user during pre-board scenario 204 of FIG. 2. However, one skilled in the art could appreciate that the functions of FIG. 6 are not limited to a pre-board scenario or to the particular functions listed in FIG. 6, and rather may include any suitable functions related to initially boarding a cruise or be used in any suitable situation.

As generally indicated in diagram 600, a user can receive a confirmation of the cruise (e.g., confirmed date and time of departure) and receive last-minute instructions for boarding the cruise (e.g., a particular time for the user's group to board the cruise, safety instructions, or other suitable information), request upgrades, request any available cruise services, or perform any other suitable functions related to initially boarding a cruise through the integrated application. For example, user interface 602 shows an exemplary interface in which a user is informed that “boarding is now open” for the cruise, and that the user should “come to Pier 42.” As another example, user interface 604 shows an exemplary interface in which a user is provided with check-in information such as check-in time, departure time, required documents, or any other suitable information.

As is also indicated in diagram 600, functions can be provided related to cruise activities. Oftentimes, cruises offer an overwhelming number and variety of cruise activities to a customer. For example, the cruise may offer a variety of onboard cruise activities (e.g., shows, health club classes such as spinning, yoga, and rock climbing, casinos, shops, pools, organized games, poker tournaments, demonstrations such as ice carving and napkin folding, spa trips, clubs, and any other suitable cruise activity onboard the cruise ship) and a variety of onshore cruise activities, referred to as “excursions,” that may be purchased through the cruise service provider (e.g., museum trips, aquarium trips, horseback riding, snorkeling, surfing, hiking and scuba diving, and any other suitable onshore cruise activity).

Moreover, cruise activities can provide customers and cruise service providers with unique opportunities that may not be available in, for example, other vacations or trips. For example, a customer on a cruise may already be vested financially and emotionally into a cruise service when embarking on the cruise. For example, a customer on a cruise may have already made significant purchases (e.g., cruise ship tickets, clothing for the trip, or other purchases) and thus may be in a “vacation mindset” and more willing to spend money on additional purchases such as cruise activities. Also, as the customer has purchased cruise ship tickets and is traveling on the cruise ship, it is likely the customer has already interacted with the cruise service provider and is familiar with them. Thus, a customer may be more willing and open to receiving information regarding additional purchases (e.g., purchasing upsells, purchasing excursions, purchasing cruise activities, or any combination of the above) from the cruise service provider than they would be in other situations. Thus, cruise service providers are given a unique opportunity to offer cruise activities to an audience who may not only be eager to receive such offers, but may also be relatively likely to purchase the cruise activities. Similarly, cruise activities can give customers the unique opportunity to receive information and offers that are not only convenient and fit into their travel plans, but may also be offered by a service provider that is known and familiar to the customer.

Typically, while on a cruise, a customer may receive a pamphlet under their door listing the cruise activities that are available for that day. Thus, a customer may not know more than a day in advance what cruise activities are available, and may not have an efficient way of searching for, locating, or organizing the available cruise activities.

Thus, in some embodiments, a single, integrated application for accessing cruise services can provide a user with a listing of all available cruise activities and their related information before the user initially boards the cruise, or during any suitable portion of the cruise (e.g., while onboard the cruise or while onshore). Furthermore, through the application, the user may be able to sort the cruise activities (e.g., by time, preference, rating, or type of cruise activity) or search for particular cruise activities that may be of interest to the user. As will be described in more detail below, in some embodiments the cruise service provider may provide notifications of an available cruise activity to a user through the integrated application. Through the integrated application, the user may then be able to view information regarding that cruise activity or, if the cruise activity requires a fee, purchase that cruise activity.

As also indicated in diagram 600, functions can be provided related to creating a user profile. For example, user interface 606 shows an exemplary interface for allowing a user to create a user profile, view their user profile, or both. The user profile can be created before the user initially boards the cruise, or during any other suitable portion of the cruise. The user profile can include information such as, for example, the user's age, gender, marriage or relationship status, interests, food preferences, activity preferences, or any other suitable information. In some embodiments, the integrated application can utilize the user profile for social networking. For example, user profiles of various customers on the cruise can be compared to help customers with matching interests locate one another. Through the application, customers on the cruise can, for example, meet workout buddies, meet people who may want to go to shows or clubs together, organize various teams or games (e.g., locate a group of people who want to play a basketball game that day), or can be provided with any other suitable social networking opportunities. In some embodiments, the user profile can be utilized to provide the customer with a targeted listing of available cruise activities (e.g., a user who is interested in equestrian activities can be provided with a listing of available horseback riding excursions).

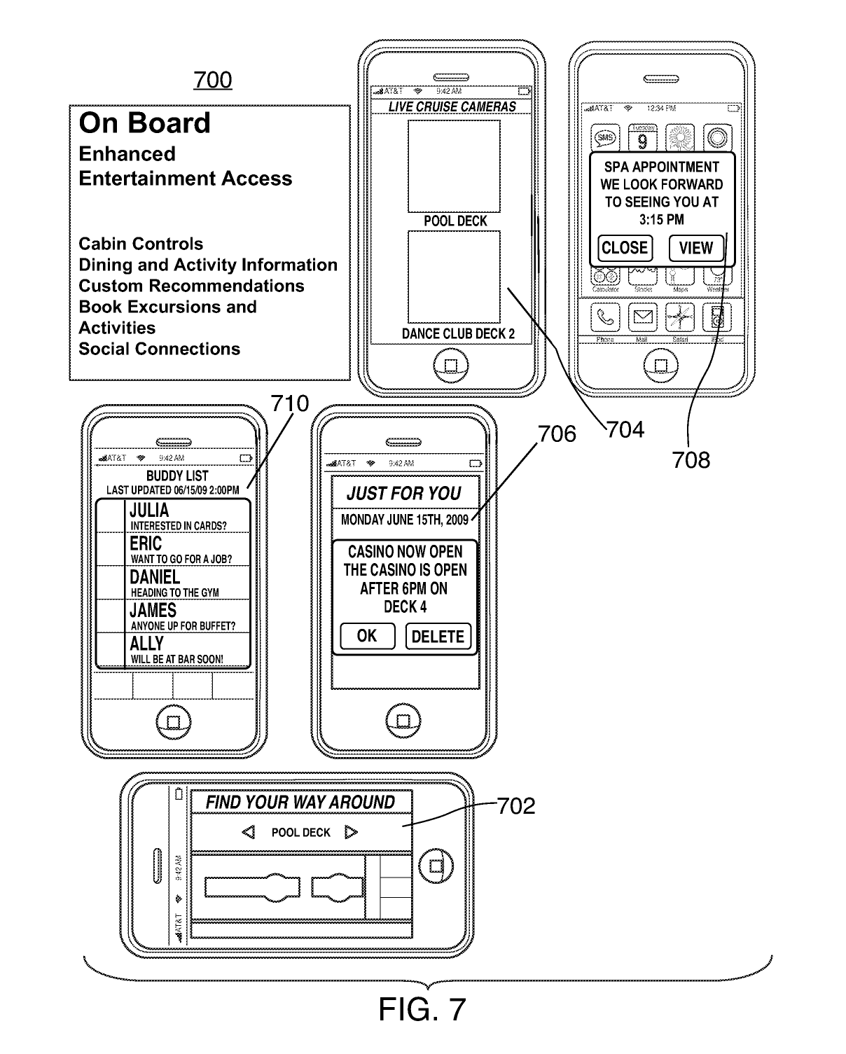

FIG. 7 shows diagram 700 of functions related to onboard proceedings that may be available to a user through a single, integrated application for accessing cruise services. For example, the functions of FIG. 7 may be available to a user during onboard scenario 206 of FIG. 2. However, one skilled in the art could appreciate that the functions of FIG. 7 are not limited to an onboard scenario or to the particular functions listed in FIG. 7, and rather may include any suitable functions related to onboard proceedings or may be used in any suitable scenario.

As generally indicated in diagram 700, a user can control aspects of their cruise ship cabin such as heat, air conditioning, and lighting, and can control a television, speakers, or other entertainment system in the cabin through the integrated application. In this manner, an electronic device utilizing the integrated application can function as a remote controller, and even as a universal remote controller. As another example, the integrated application can provide a menu or user interface through which the user can purchase items or place orders (e.g., order room service or make reservations at a restaurant or show in the cruise ship).

As another illustration, information related to the cruise can be provided such as, for example, interactive maps of the cruise ship showing the locations of stores, pools, gyms, or other available services, the weather forecast (e.g., for the cruise ship or for a city in which the cruise ship is scheduled to dock), and security information (e.g., locations of life rafts and vests or information on what to do in the event of an emergency). For example, user interface 702 shows an exemplary interface with an interactive map of a cruise ship on which the user is traveling. As another illustration, user interface 704 shows an exemplary interface that can provide streaming of live video feeds from various areas of the cruise ship. As another illustration, the user can be provided with information regarding the hours of various stores and activities on the cruise ship. For example, user interface 706 shows an exemplary interface in which a customer is informed of when the cruise ship's venues will be open.

As is also indicated in diagram 700, functions related to onboard cruise activities may also be provided. Similar to the description of cruise activities with regard to diagram 600 of FIG. 6, a listing of available onboard cruise activities may be provided to the user. In some embodiments, a user can be provided with reminders of purchased activities (e.g., on-board activities, excursions, or both). For example, user interface 708 shows an exemplary pop-up message reminding a user of a scheduled appointment. In some embodiments, the cruise service provider can communicate notifications of available or unsold cruise activities to a user for potential purchasing. Furthermore, the unsold cruise activities can be matched to a user profile of the user to provide the user with targeted notifications. Ways in which a cruise service can provide notifications of cruise activities to a user will be described in more detail in the descriptions to follow.

As shown in diagram 700, functions related to social networking may also be provided. For example, the electronic device may include a positioning system which the integrated application can utilize to determine where on the cruise ship the user is located. The positioning system can include any suitable system such as, for example, a global positioning system (“GPS”) receiver for accessing a GPS application function call that returns the geographic coordinates (i.e., the geographic location) of the electronic device. As another illustration, the positioning system can utilize any suitable trilateration or triangulation technique to determine the geographic coordinates of the electronic device. In some embodiments, the positioning system can determine various measurements (e.g., signal-to-noise ratio (“SNR”) or signal strength measurements) of a network signal (e.g., a cellular telephone network signal, a wireless network access point or “hot spot,” or any other suitable network signal) associated with the electronic device to determine its location.

Once a user's location has been determined, a map of the cruise ship can be displayed that indicates the location of the user. The integrated application may also receive data related to the locations of acquaintances or friends who are also on the cruise ship. For example, a friend's electronic device can include a positioning system to determine the friend's location. The friend's electronic device can then transmit this location information to the user's electronic device. In response to determining that a friend is in the nearby vicinity, the integrated application may then provide a notification that the friend is nearby, display a map showing the location of the friend, or both. As another example, the integrated application may keep track of the entire population on the cruise ship. The integrated application may then provide notifications to the user indicating where the “popular spots” are in which a large number of people are located (e.g., a particular club that is popular that night). As another example, as illustrated by user interface 710, the integrated application can include a message interface to allow a user to communicate with acquaintances (e.g., acquaintances who are also on the cruise).

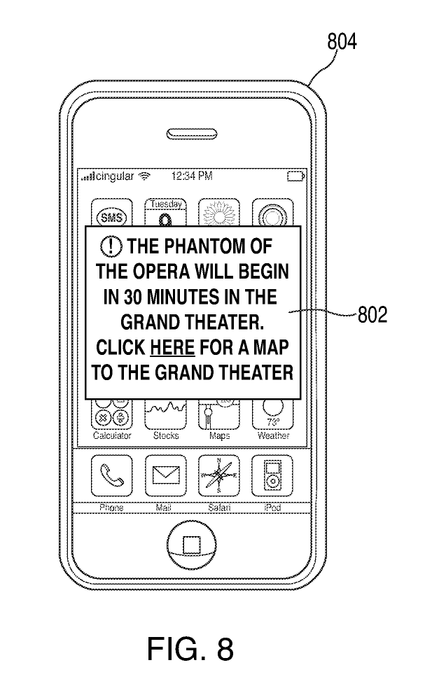

In some embodiments, a user can be provided with a notification when an onboard cruise activity of interest is going to start. For example, a user may have indicated that they are interested in seeing a particular show that night. As illustrated in FIG. 8, the integrated application may then provide warning notification 802 on electronic device 804 that the show will be beginning shortly (e.g., in 30 minutes).

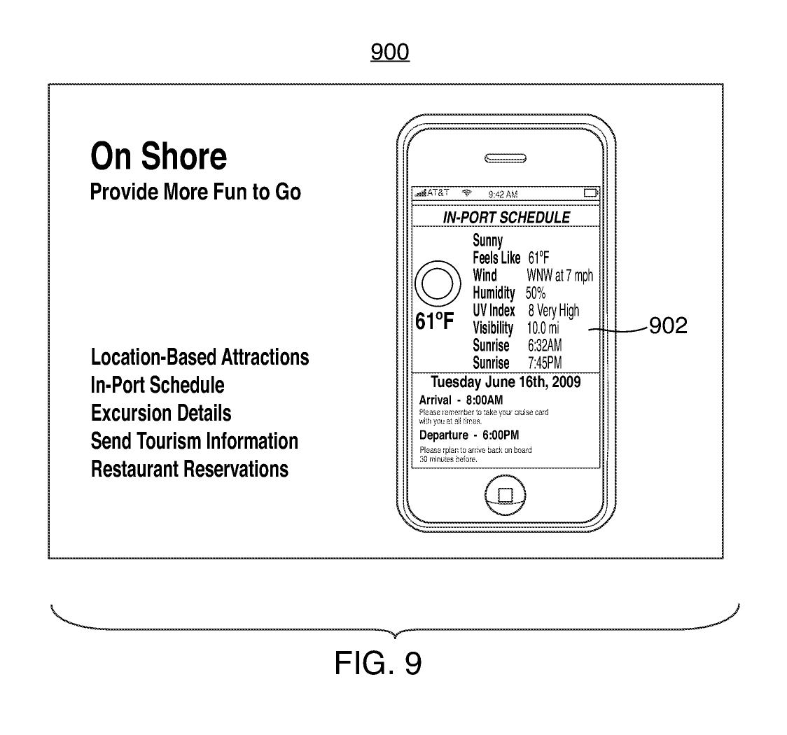

FIG. 9 shows diagram 900 of functions related to onshore proceedings that may be available to a user through a single, integrated application. For example, the functions of FIG. 9 may be available to a user during onshore scenario 208 of FIG. 2. However, one skilled in the art could appreciate that the functions of FIG. 9 are not limited to an onshore scenario or to the particular functions listed in FIG. 9, and rather may include any suitable functions related to onshore proceedings or be used in any suitable scenario.

As generally indicated in diagram 900, an integrated application for accessing cruise services can provide a day schedule to a user when they are onshore. For example, the schedule can include information such as the times of available or purchased excursions (i.e., onshore cruise activities), the times of any other suitable activities, the time the user is required to return to the ship, or any other suitable information. As another example, information such as local weather of the city in which the cruise ship will dock can be provided. For example, user interface 902 shows an exemplary interface that can provide a user with information such as local weather, port arrival time, port departure time, or any other suitable information. In some embodiments the user can be provided with an opportunity to view or purchase available excursions. For example, a push notification can be transmitted to the user that informs the user of excursions that are available for purchase.

As described above, in addition to onshore cruise activities (i.e., “excursions”), cruise service providers can additionally or alternatively offer onboard cruise activities to cruise customers. Both types of cruise activities can be activities which are free for the cruise customers to attend (e.g., free shows onboard the cruise, organized games, demonstrations, or any other suitable free cruise activity) or can be activities which are purchased (e.g., spa appointments, excursions such as snorkeling trips, scuba diving trips, horseback riding trips, or any other suitable cruise activity which is purchased).

Accordingly, to inform a cruise ship customer of available cruise activities, the cruise service provider may offer these cruise activities through an integrated cruise application on a customer's electronic device (e.g., electronic device 100 of FIG. 1). In some embodiments, a notification can be provided on the user's electronic device that includes information regarding the cruise activity (e.g., notification 802 of FIG. 8). For example, a push notification can be provided that includes information such as the name of the cruise activity, the time and location of the cruise activity, a description of the cruise activity, and any other suitable information. In some embodiments, the user can be provided with a listing of cruise activities that, for example, can be accessed through menu options of the integrated application. In this case, the integrated application can provide functions such as sorting the cruise activities, running searches on the cruise activities, displaying a truncated list including popular cruise activities, or any other suitable function.

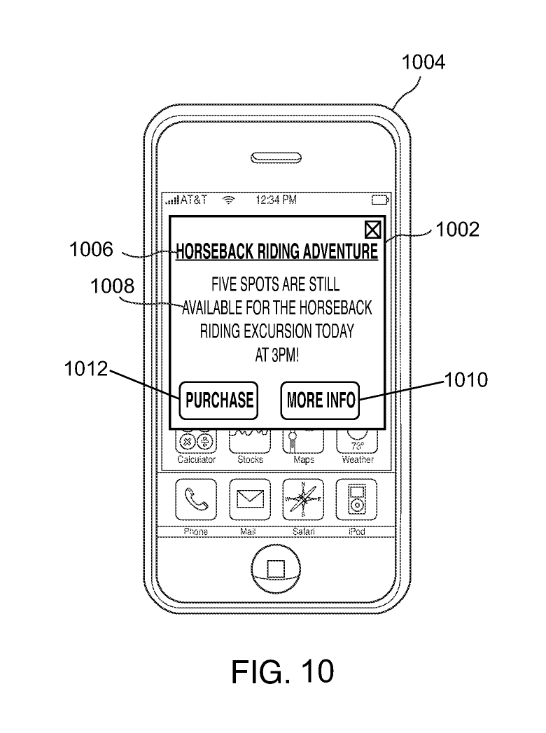

In some embodiments, cruise activities which must be paid for can be offered to a cruise customer for purchasing. For example, a cruise service provider can identify cruise activities that are unsold (e.g., spots on an available excursion that have not yet been sold, unsold tickets to a show, or any other suitable, unsold cruise activity). The cruise customer may then be provided with an opportunity to view information regarding the unsold cruise activity, purchase the unsold cruise activity, or both. For example, FIG. 10 shows notification 1002 of an unsold cruise activity that can be provided on electronic device 1004. Notification 1002 can include, for example, title 1006, descriptive information 1008, information link 1010 to more information regarding the unsold cruise activity, and purchase option 1012. Purchase option 1012 may, for example, allow the cruise customer to access a secure connection through which they can enter credit card/banking information to purchase one or more of the unsold cruise activities, allow the cruise customer to charge the unsold cruise activity to their room number, or in any other suitable way allow the cruise customer to purchase the unsold cruise activity.

Notification 1002 can be provided through electronic device 1004 at any suitable time or in any suitable manner. For example, notification 1002 can be provided before a cruise customer initially boards a cruise (e.g., in pre-cruise scenario 202, pre-board scenario 204, or both of FIG. 2) and may include a listing of all unsold cruise activities for the full period of the cruise. As another example, notification 1002 of an unsold cruise activity can be provided a certain period of time before the unsold cruise activity begins (e.g., one hour beforehand, 30 minutes beforehand, or any other suitable period of time beforehand). As another example, notification 1002 can be provided each morning (e.g., every morning at 7 AM). In this scenario, notification 1002 may include a listing of all unsold cruise activities available for that day. In addition, notification 1002 can include any suitable type of notification, such as, for example, a pop-up notification that is automatically displayed, a push notification, a notification that can be manually accessed by choosing menu options of the integrated application (e.g., a menu option labeled “display unsold cruise activities”), or any other suitable type of notification.

In some embodiments, notification 1002 can provide a cruise customer with targeted, unsold cruise activities. For example, as described above, in some embodiments a user profile can be created for a cruise customer (e.g., through user interface 606 of FIG. 6). This user profile can include user information such as, for example, the cruise customer's gender, age, food preferences, activity preferences, marriage or relationship status, or any other suitable user information. The unsold cruise activities may then be compared to the user profile to determine whether they match. In response to the unsold cruise activity matching the user profile of a particular cruise customer, that unsold cruise activity may then be offered to the cruise customer for purchasing (e.g., through notification 1002). For example, unsold cruise activities such as surfing, snorkeling, and scuba diving may be offered to a cruise customer whose user profile indicates they enjoy water activities. As another example, a young, adult, male may be offered unsold tickets to a basketball game excursion and a middle-aged female may be offered an unsold spa appointment.

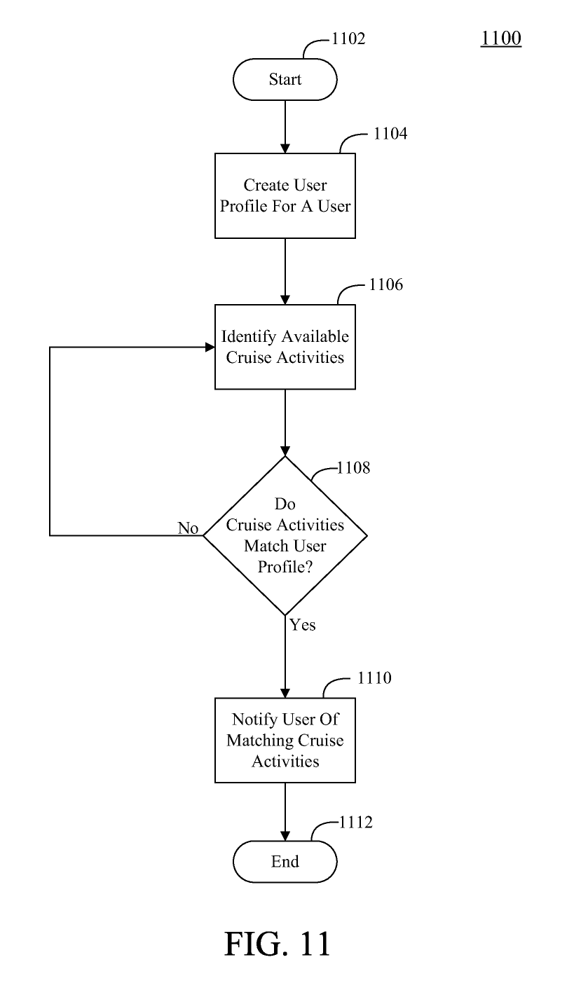

FIG. 11 shows process 1100 for providing notifications of cruise activities. Process 1100 can start at step 1102. At step 1104, a user profile can be created for a user. For example, an interface such as user interface 606 of FIG. 6 can be used to credit a user profile, edit a user profile, or both. The user profile can include information related to the user such as, for example, the user's age, gender, marriage status, interests, food preferences, activity preferences, or any other suitable information.

At step 1106, available cruise activities can be identified. For example, cruise activities such as onboard cruise activities, onshore cruise activities (e.g., excursions), or both can be identified. In some embodiments, both free cruise activities and purchasable cruise activities can be identified at step 1106. In other embodiments, only unsold cruise activities can be identified at step 1106. For example, when it is desirable to only present notifications to a user regarding cruise activities that can be purchased (e.g., in order to generate revenue), then it may be suitable to only identify unsold cruise activities, rather than identifying both free and purchasable cruise activities.

At step 1108, the cruise activities identified at step 1106 can be compared to the user profile created at step 1104 to determine whether they match. For example, each cruise activity can be associated with metadata related to attributes of the cruise activity, attributes of customers who may enjoy that cruise activity, or both. The metadata can define, for example, attributes such as age groups, genders, the type of cruise activity, the time of the cruise activity, the location of the cruise activity, or any other suitable attributes. In response to there not being a match, process 1100 can return to step 1106 and continue repeating steps 1106 and 1108. In this manner, process 1100 can continue identifying cruise activities until a cruise activity matching the user profile is identified.

In response to a cruise activity matching the user profile, process 1100 can proceed to step 1110. At step 1110, the user can be notified of the matching cruise activity. For example, a notification such as notification 1002 of FIG. 10 can be provided. In some embodiments, when the matching cruise activity is an unsold cruise activity, the user can be provided with an option to purchase the matching cruise activity at step 1112. Process 1100 may then end at step 1114.

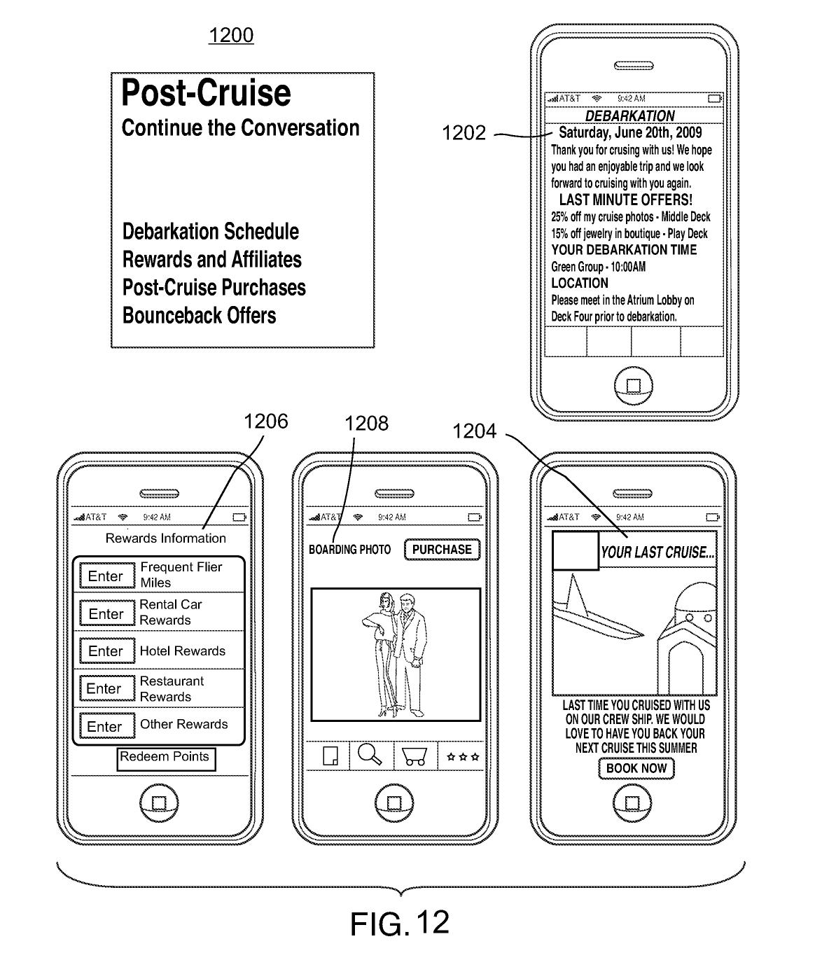

FIG. 12 shows diagram 1200 of functions related to post-cruise proceedings that may be available to a user through a single, integrated application. For example, the functions of FIG. 12 may be available to a user during post-cruise scenario 210 of FIG. 2. However, similar to diagrams 400, 600, 700, and 900, the functions of FIG. 12 are not limited to a post-cruise scenario or to the particular functions listed in FIG. 12, and rather may include any suitable functions related to post-cruise proceedings or may be used in any suitable scenario. In particular, one skilled in the art could appreciate that any of the functions of an integrated cruise application described herein could be made available during any suitable portions of a user's cruise experience.

As generally indicated in diagram 1200, a user can access debarkation information through a single, integrated application. For example, user interface 1202 shows an exemplary interface of an integrated application that can provide a user with debarkation information. As is also generally indicated in diagram 1200, a user can access final destination information (e.g., information about the final destination where the cruise ship will dock and maps to where taxis, rental cars, or other transportation may be found), receive bounceback offers, and receive offers from affiliate programs. For example, user interface 1204 shows an exemplary interface that can provide a user with a bounceback offer to book another cruise with the cruise service provider. As another example, as illustrated by user interface 1206, a user can be provided with an opportunity to enter, view, and modify rewards information.

In some embodiments, a user can be provided with opportunities to buy mementos or souvenirs related to the cruise. For example, user interface 1208 shows an exemplary interface that can provide a user with an opportunity to purchase a photo taken of the user when the user initially boarded the cruise. In some embodiments, the electronic device can automatically save and store receipts from the cruise ship and other service providers (e.g., restaurants, transportation, excursions, and entertainment) to facilitate the user's post-trip experience (e.g., gathering receipts for budget-related information).

The process discussed above is intended to be illustrative and not limiting. Persons skilled in the art could appreciate that steps of the process discussed herein can be omitted, modified, combined, or rearranged, and any additional steps can be performed without departing from the scope of the invention.

In addition, it will be apparent to those of ordinary skill in the art that methods involved in the invention may be embodied in a computer program product that includes a machine readable and/or usable medium. For example, such a computer usable medium may consist of a read-only memory device, such as a CD ROM disk or conventional ROM device, or a random access memory, such as a hard drive device or a computer diskette, or flash memory device having a computer readable program code stored thereon.

The above-described embodiments of the invention are presented for purposes of illustration and not of limitation.

What is claimed is:

1. A method comprising:
creating a user profile comprising user information associated with a customer on a cruise;
identifying at least one unsold cruise activity of the cruise;
determining the unsold cruise activity matches at least a portion of the user information; and
providing a notification regarding the unsold cruise activity to a portable electronic device of the customer in response to the determining.

2. The method of claim 1, wherein the notification comprises an opportunity to purchase the unsold cruise activity.

3. The method of claim 1, wherein the unsold cruise activity comprises at least one of an unsold onboard cruise activity and an unsold excursion.

4. The method of claim 1, wherein the user information comprises at least one of user preference information, age, gender, and relationship status.

5. The method of claim 1, wherein the determining comprises:
identifying at least one attribute of the unsold cruise activity;
comparing the identified at least one attribute to the user information; and
determining the identified at least one attribute matches at least a portion of the user information.

6. The method of claim 1, wherein providing the notification comprises:
displaying the notification on the portable electronic device of the customer in response to the determining.

7. The method of claim 1, wherein the notification is provided a predetermined period of time before the unsold cruise activity is scheduled to begin.

8. The method of claim 1, wherein the identifying, determining, and providing are repeated each day of the cruise at a predetermined time of day.

9. The method of claim 1, wherein the identifying, determining, and providing are repeated on a predetermined periodic basis.

10. A portable electronic device comprising:
an input component operable to receive user preference data associated with a customer on a cruise;
communication circuitry operable to:
transmit the user preference data to a remote server of the cruise; and
receive notification data associated with at least one unsold excursion of the cruise from the remote server, wherein the at least one unsold excursion matches at least a portion of the user preference data; and
a display device operable to display the notification data, wherein the notification data comprises an option to purchase the at least one unsold excursion.

11. The portable electronic device of claim 10, wherein the notification data further comprises at least one of location, time, and descriptive information of the at least one unsold excursion.

12. The portable electronic device of claim 10, wherein the communication circuitry is further operable to receive information associated with at least one of a map of a cruise ship of the cruise, promotions associated with the cruise, and onboard cruise activities.

13. The portable electronic device of claim 10, wherein the communication circuitry is further operable to transmit a room service order to the remote server.

14. The portable electronic device of claim 10, wherein the communication circuitry is further operable to transmit a signal operable to control at least one of an entertainment system, lighting, and temperature in a cabin room of the customer.

15. A system comprising:
a database operable to store user information associated with a customer on a cruise;
a processor operable to:
identify a purchasable cruise activity that comprises at least one unsold spot;
identify metadata associated with the identified cruise activity;
determine the identified metadata matches at least a portion of the stored user information; and
provide an offer to buy the identified cruise activity to the customer in response to the determining.

16. The system of claim 15, further comprising:
communication circuitry operable to transmit a push notification to a portable electronic device of the customer in response to the processor determining, wherein the push notification comprises information associated with the identified cruise activity.

17. The system of claim 16, wherein the information associated with the identified cruise activity comprises at least one of a name of the identified cruise activity, a time of the identified cruise activity, a location of the identified cruise activity, a description of the identified cruise activity, and a link to additional information associated with the identified cruise activity.

18. The system of claim 15, further comprising:
communication circuitry operable to receive a request to receive cruise activity offers from a portable electronic device of the customer; and wherein
the processor is further operable to provide the offer to buy the identified cruise activity to the customer in response to the communication circuitry receiving the request.

19. The system of claim 15, wherein the processor is further operable to:
provide an opportunity to charge a purchase of the identified cruise activity to a room number of the customer.

20. Machine-readable media for providing a notification of an unsold cruise activity, comprising machine-readable instructions recorded thereon for:
creating a user profile comprising user information associated with a customer on a cruise;
identifying at least one unsold cruise activity of the cruise;
determining the unsold cruise activity matches at least a portion of the user information; and
providing a notification regarding the unsold cruise activity to the customer in response to the determining.

21. The machine-readable media of claim 20, wherein the notification comprises an opportunity to purchase the unsold cruise activity.
